(19) United States
(12) Patent Application Publication
(10) Pub. No.: US 2006/0239495 A1
(43) Pub. Date: Oct. 26, 2006

(54) Speaker device

(76) Inventors: Yasuhisa Abe, Yamagata (JP); Daisuke Takahashi, Yamagata (JP)

Correspondence Address: YOUNG & THOMPSON, 745 SOUTH 23RD STREET, 2ND FLOOR, ARLINGTON, VA, 22202, US

(21) Appl. No.: 11/410,039

(22) Filed: Apr. 25, 2006

(30) Foreign Application Priority Data
Apr. 26, 2005 (JP) 2005-128110

(51) Int. Cl. H04R 1/02

(52) U.S. Cl. 381/386

(57) ABSTRACT

A speaker device includes a first cabinet on which a speaker unit is mounted, a second cabinet which is engaged with the first cabinet, and a logo-mark printed panel and a metal attaching side panel mounted on a one side surface or other side surface opposite to the one side surface of a cabinet manufactured when the first cabinet and the second cabinet are engaged. Particularly, in the speaker device, the one side surface of the cabinet is formed into the same shape as the other side surface of the cabinet, and the logo-mark printed panel and the metal attaching side panel are formed into shapes to be engaged with the one side surface and the other side surface, respectively.

### BACKGROUND OF THE INVENTION

1. Field of the Invention

The present invention relates to a configuration of a housing for a speaker device.

2. Description of Related Art

Conventionally, a speaker for a vehicle is normally used in such a state that it is mounted on an inner panel of a door and/or on a rear tray provided behind a backseat. However, since some vehicles have no rear tray, a speaker for a vehicle mountable on a part other than the rear tray is desired.

In such a situation, a speaker for a vehicle, referred to as “satellite-type speaker”, used in such a state that it is mounted on a part other than the rear tray, e.g., a trim and an assist grip in a vehicle interior, is put to practical use.

When the satellite-type speaker is used for the vehicle, a pair of speakers for left and right channels is normally used. In this case, one of the pair of speakers is used in such a state that it is mounted on the rear trim provided on a backward left side in the vehicle interior, and the other is used in such a state that it is mounted on the rear trim on a backward right side in the vehicle interior, for example. Thus, the speaker for the left channel functions to output an acoustic wave into a left space in the vehicle interior with respect to a traveling direction of the vehicle, and the speaker for the right channel functions to output the acoustic wave into a right space in the vehicle interior with respect to the traveling direction of the vehicle.

As the speaker of this kind, there is proposed a speaker suspended from a ceiling for a vehicle, having an easily-mounting configuration in which no cutting process of a ceiling material of the vehicle is necessary (see Japanese Patent Application Laid-open under No. 2002-144973, for example). In this speaker, a speaker case is spherically rotatable, and a center of sound output can be adjusted to a passenger on a backseat.

In addition, there is proposed a speaker mounting equipment for a vehicle, for easily mounting a speaker cabinet at a position other than the rear tray (see Japanese Patent Application Laid-open under No. 10-157523, for example). The speaker mounting equipment for the vehicle disclosed in this reference includes a first fixing part fixing to an upper edge of a rear gate in the vehicle, a second fixing part fixing to an upper edge of a side gate, and a shaft rotatably connected with the first fixing part and the second fixing part. The speaker cabinet is fixed to be sandwiched by the shaft and the ceiling of the vehicle. Hence, the speaker cabinet can be easily mounted on the part other than the rear tray.

In the above-mentioned satellite-type speaker, mounting positions of metal fitting parts to be mounted on mounting bases are different between the speaker for the left channel and the speaker for the right channel. Additionally, mounting directions in the vehicle interior are also different between both of the speakers. Therefore, a cabinet for the left channel and a cabinet for the right channel are individually manufactured, and the speaker for the left channel and the speaker for the right channel are formed. Since component parts such as the cabinets are individually manufactured for the speaker for the left channel and the speaker for the right channel in this manner, the number of metal mold parts problematically increases. Further, at a stage of the component part level, individually manufacturing and managing of them are problematically necessary.

### SUMMARY OF THE INVENTION

The present invention has been achieved in order to solve the above problems. It is an object of this invention to provide a speaker device reducing the number of metal mold parts and enabling easy management of each component part.

According to one aspect of the present invention, there is provided a speaker device including: a first cabinet on which a speaker unit is mounted; a second cabinet which is engaged with the first cabinet; a first side panel which is mounted on one side surface of the first cabinet and the second cabinet when the first cabinet and the second cabinet are engaged; and a second side panel which is mounted on other side surface, opposite to the one side surface, of the first cabinet and the second cabinet when the first cabinet and the second cabinet are engaged, wherein the one side surface and the other side surface are formed into a same shape, and each of the first side panel and the second side panel is formed into a shape to be engaged with the one side surface and the other side surface.

The above speaker device includes the first cabinet on which the speaker unit serving as a generation source of a sound is mounted, the second cabinet which is engaged with the first cabinet, and first and second side panels which are mounted on the one side surface of the first cabinet and the second cabinet or on the other side surface opposite to the one side surface when the first cabinet and the second cabinet are engaged. Here, the first cabinet and the second cabinet in the engaged state are simply called “cabinet”, for convenience.

Particularly, in the speaker device, the one side surface and the other side surface of the cabinet are formed into the same shape, and the first side panel and the second side panel are formed into the shape to be engaged with the one side surface and the other side surface, respectively. In a preferred example, the first side panel mounted on the one side surface or the other side surface is formed into the substantially same shape as the second side panel mounted on the one side surface or the other side surface.

Therefore, as for the speaker device for the vehicle, when at least one pair of speaker devices for the left and right channels have to be provided in the vehicle interior, each of the component parts, i.e., the first cabinet, the second cabinet, the first side panel and the second side panel, can be shared between the speaker device for the left channel and the speaker device for the right channel, respectively. Thus, the number of metal mold parts for manufacturing each of the above-mentioned component parts can be reduced, as compared with the speaker device whose component parts cannot be shared. In addition, since the number of component parts can be reduced, the management of each component part becomes easy.

In a manner of the above speaker device, an opening through which a wiring electrically connected to a voice coil of the speaker unit is drawn to outside may be formed on the one side surface and the other side surface of the second cabinet, and the opening formed on the one side surface may be formed at a position corresponding to the opening formed on the other side surface.

In accordance with this manner, the opening through which the wiring electrically connected to the voice coil of the speaker unit is drawn to outside is formed on the one side surface and the other side surface of the second cabinet. Thereby, the wiring electrically connected to the voice coil of the speaker unit can be drawn to outside through the opening. Therefore, it becomes possible to connect the wiring and the output terminal of the amplifier. In addition, the opening formed on the one side surface of the second cabinet is formed at the position corresponding to the opening formed on the other side surface of the second cabinet. Thus, the wiring can be drawn to outside through the opening formed on the one side surface. Meanwhile, inversely, the wiring can be drawn to outside through the opening formed on the other side surface. Hence, when the directions of wiring drawing to outside have to be different between the speaker device for the left channel and the speaker device for the right channel, this can be realized. Namely, when the wirings are drawn to outside, the respective openings can be shared between the speaker device for the left channel and the speaker device for the right channel.

In another manner of the above speaker device, the second side panel may have an opening at a position corresponding to the opening of the second cabinet when the second side panel is mounted on the one side surface or the other side surface.

In accordance with this manner, the second side panel has the opening at the position corresponding to the opening of the second cabinet when the second side panel is mounted on the one side surface or the other side surface. Thereby, the wiring electrically connected to the voice coil of the speaker unit can be drawn to outside through the opening of the second cabinet and the opening of the second side panel.

In another embodiment of the above speaker device, the second cabinet may have a mounting portion on which a metal fitting part for mounting on a mounting base is mounted. Therefore, by mounting the metal fitting part (e.g., a metal fitting part such as a flexible arm whose angle can be adjusted) on the mounting portion of the second cabinet, the speaker device can be mounted on the mounting base via the metal fitting part.

In another manner of the above speaker device, the first side panel may have a bass reflex duct at a position corresponding to the opening formed on the one side surface and the other side surface.

In this manner, the first side panel may have the bass reflex duct at the position corresponding to the opening of the second cabinet, formed on the one side surface and the other side surface. Therefore, when the first side panel is mounted on the one side surface, the bass reflex duct can be provided on the one side surface. Inversely, when the first side panel is mounted on the other side surface, the bass reflex duct can be provided on the other side surface. Hence, the bass reflex duct can be shared between the speaker device for the left channel and the speaker device for the right channel.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIGS. 1A to 1D show a front view, a rear view, a left-side view and a right-side view of a speaker device according to a first embodiment of the present invention, respectively;

FIGS. 2A and 2B show cross-sectional views of the speaker device along each cutting-line shown in FIG. 1C;

FIGS. 3A and 3B show a front view and a rear view of a first cabinet according to the first embodiment;

FIGS. 4A and 4B show a side view and a cross-sectional view of the first cabinet according to the first embodiment;

FIGS. 5A and 5B show a front view and a rear view of a second cabinet according to the first embodiment;

FIG. 5C shows a side view of a metal fitting part shown in FIG. 5B;

FIGS. 6A and 6B show a left-side view and a right-side view of the second cabinet according to the first embodiment;

FIGS. 7A to 7C show a front view and each side view of a logo-mark printed panel according to the first embodiment;

FIGS. 8A and 8B show a rear view and a cross-sectional view of the logo-mark printed panel according to the first embodiment;

FIGS. 9A to 9C show a front view and each side view of a metal attaching side panel according to the first embodiment;

FIGS. 10A and 10B show a rear view and a cross-sectional view of the metal attaching side panel according to the first embodiment;

FIGS. 11A and 11B show a left-side view and a right-side view of the cabinet according to the first embodiment;

FIG. 12 shows an example of mounting the speaker device according to the first embodiment onto a vehicle interior;

FIGS. 13A to 13D show a front view, a rear view, a left-side view and a right-side view of the speaker device according to a second embodiment of the present invention, respectively; and

FIGS. 14A to 14C show a front view and each side view of the logo-mark printed panel according to the second embodiment.

### DETAILED DESCRIPTION OF THE PREFERRED EMBODIMENTS

The preferred embodiments of the present invention will now be described below with reference to the attached drawings.

### First Embodiment

(Configuration of Speaker Device)

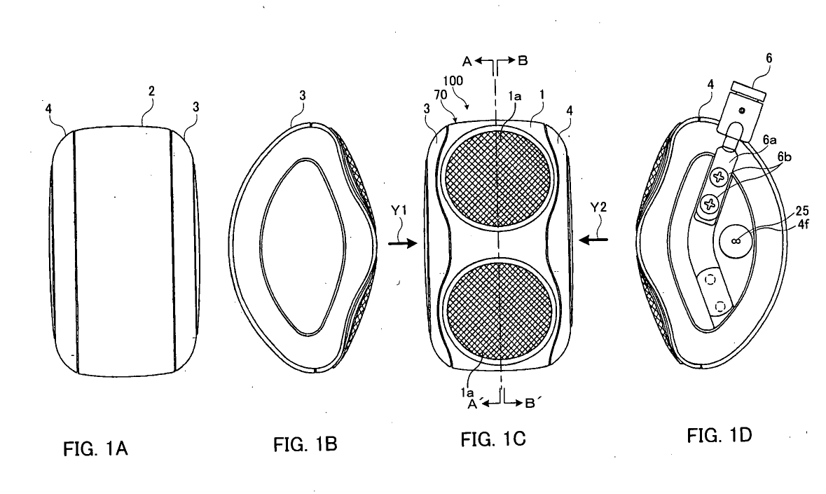

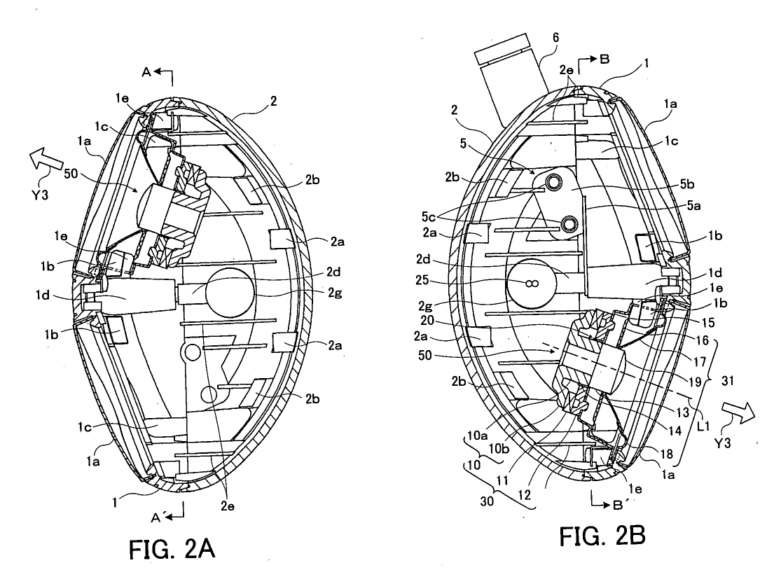

First, a description will be given of a configuration of a speaker device 100 according to a first embodiment of the present invention with reference to FIGS. 1A to 1D and FIGS. 2A and 2B.

FIGS. 1A to 1D show views of the speaker device 100 according to the first embodiment of the present invention when observed from a front direction, a rear direction, a left direction and a right direction thereof, respectively. Concretely, FIG. 1C shows a front view of the speaker device 100, and FIG. 1A shows a rear view of the speaker device 100. FIG. 1B shows a left-side view of the speaker device 100 shown in FIG. 1A when observed from an arrow Y1 direction. FIG. 1D shows a right-side view of the speaker device 100 shown in FIG. 1A when observed from an arrow Y2 direction opposite to the arrow Y1 direction. FIG. 2A shows across-sectional view along a cutting-line A-A′ shown in FIG. 1C, and FIG. 2B shows a cross-sectional view along a cutting-line B-B′ shown in FIG. 1C.

The speaker device 100 includes a speaker unit 50 serving as the generation source of the sound, a housing which houses the speaker unit 50, and a flexible arm 6 with which the housing is mounted on a mounting base. The speaker device 100 is a satellite-type speaker device preferable as the speaker device for the vehicle. When the speaker device 100 is used for the vehicle, at least one pair of speaker devices for left and right channels are used.

First, a description will be given of a configuration of the speaker unit 50 with reference to FIG. 2B.

The speaker unit 50 mainly includes a magnetic circuit 30 having a yoke 10, a magnet 11 and a plate 12, and a vibration system 31 having a voice coil bobbin 13, a voice coil 14, a damper 16, a diaphragm 17, an edge 18 and a cap 19. In the present invention, the configuration and a driving system of the speaker unit 50 are not limited to a configuration and a driving system which will be explained below.

First, a configuration of the magnetic circuit 30 will be explained. The magnetic circuit 30 is configured as an external magnet type magnetic circuit. The yoke 10 has a pole portion 10a formed into a cylindrical shape and a flange portion 10b outwardly extending from a lower end portion of an outer peripheral wall of the pole portion 10a. The magnet 11, which is formed into an annular shape, is mounted on the flange portion 10b. The plate 12, which is formed into an annular shape, is mounted on the magnet 11. The magnetic flux of the magnet 11 is concentrated on a space (magnetic gap 20) formed between the outer peripheral wall of the pole portion 10a being a component of the yoke 10 and an inner peripheral wall of the plate 12.

Next, a configuration of the vibration system 31 will be explained.

The voice coil bobbin 13, formed into a cylindrical shape, is provided at a position covering the vicinity of the upper end portion of the outer peripheral wall of the pole portion 10a being the component of the yoke 10.

The voice coil 14 has one wiring, which includes a plus lead wire and a minus lead wire (not shown), and it is wound around the vicinity of a lower end portion of an outer peripheral wall of the voice coil bobbin 13. The plus lead wire is an input wiring for an L (or R)-channel signal, and the minus lead wire is an input wiring for a ground (GND:ground) signal. Each of the plus lead wire and the minus lead wire is connected to one end of each tinsel cord (not shown), and other end of each tinsel cord is connected to a terminal portion (not shown) provided at an appropriate position of a frame 15. In addition, the terminal portion is also connected to an output wiring 25 of an amplifier. Thereby, the signal and the power of one channel are inputted to the voice coil 14 from the amplifier via the terminal portion, each tinsel cord, the plus lead wire and the minus lead wire.

The frame 15 is formed into a substantial bowl shape and has a function of supporting various kinds of component parts of the speaker unit 50. The lower end portion of the frame 15 is mounted on the plate 12.

The damper 16, which is formed into an annular shape, elastically supports the voice coil bobbin 13. An inner peripheral edge portion of the damper 16 is mounted on the vicinity of an upper end portion of the outer peripheral wall of the voice coil bobbin 13. An outer peripheral edge portion of the damper 16 is mounted on an appropriate position at the middle portion of the frame 15.

The diaphragm 17 has a function of outputting an acoustic wave corresponding to the input signal. The diaphragm 17 is formed into a cone shape. An inner peripheral edge portion of the diaphragm 17 is mounted on the upper end portion of the outer peripheral wall of the voice coil bobbin 13 at the upper side of the damper 16.

The edge 18 has an annular plan shape and an Q shaped cross-section shape, and it has a function of absorbing an unnecessary vibration generated in the speaker unit 50. An inner peripheral edge portion of the edge 18 is mounted on the outer peripheral edge portion of the diaphragm 17, and an outer peripheral edge portion of the edge 18 is mounted onto an appropriate position at the upper end portion of the frame 15.

The cap 19 is formed into a substantial dome shape and has a function of preventing dust and water from entering the inside of the speaker unit 50. The cap 19 is arranged at a position covering the upper surface of the voice coil bobbin 13 and is mounted on the upper end portion of the outer peripheral wall of the voice coil bobbin 13.

In the speaker unit 50 having the above-mentioned configuration, the electric signal outputted from the output wiring 25 of the amplifier is supplied to the voice coil 14 via the terminal portion, each tinsel cord and the plus and minus lead wires of the voice coil 14. Thereby, the driving force of the voice coil 14 is generated in the magnetic gap 20, which vibrates the diaphragm 17 in the direction of the central axis L1 of the speaker device 100. In this manner, the speaker unit 50 outputs the acoustic wave in the direction of an arrow Y3.

Next, a description will be given of a configuration of the housing which houses the speaker unit 50 having the above-mentioned configuration. Particularly, the present invention has a characteristic in the configuration of the housing.

As shown in FIGS. 1A to 1D and FIGS. 2A and 2B, the housing includes a first cabinet 1 on which the speaker unit 50 is mounted, a second cabinet 2 which is engaged with the first cabinet 1, a logo-mark printed panel 3 and a metal attaching side panel 4 mounted on side surfaces of the first cabinet 1 and the second cabinet 2 in the engaged state. Hereinafter, the first cabinet 1 and the second cabinet 2 in the engaged state are simply referred to as “cabinet 70”.

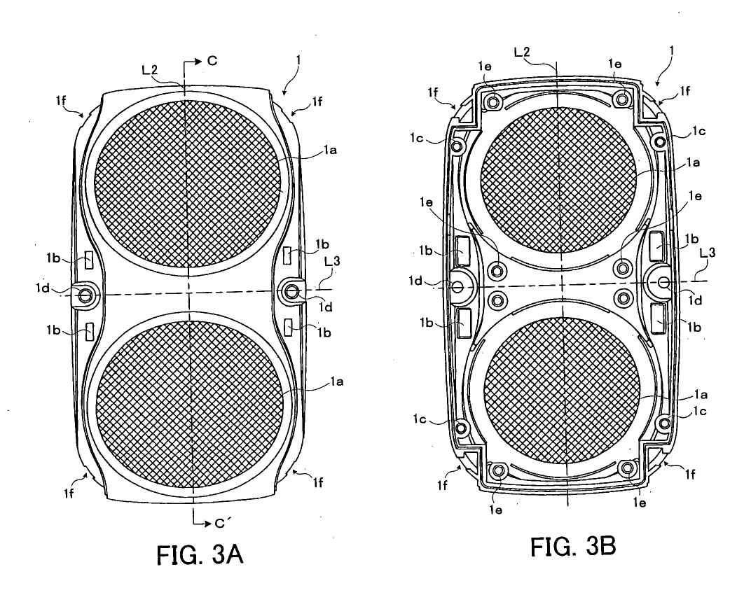

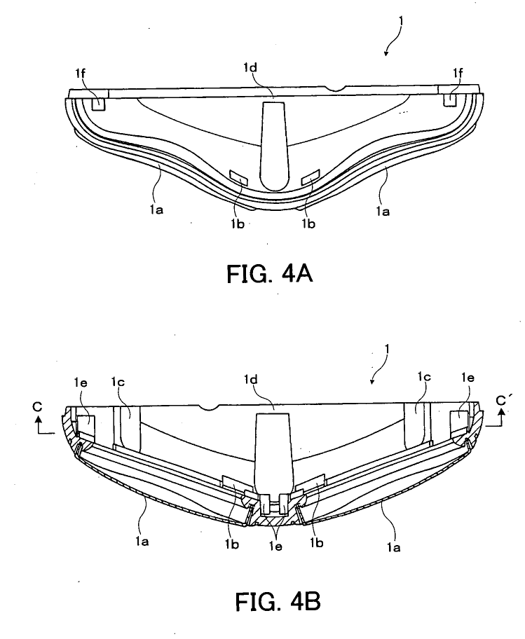

First, a configuration of the first cabinet 1 will be explained with reference to FIGS. 3A and 3B and FIGS. 4A and 4B.

FIG. 3A shows a front view of the first cabinet 1, and FIG. 3B shows a rear view thereof. FIG. 4A shows a side view thereof. FIG. 4B shows a cross-sectional view along a cutting-line C-C′ shown in FIG. 3A.

The first cabinet 1 has a substantially rectangular plane shape and a substantially triangle side shape. The first cabinet 1 includes two grilles 1a, plural hook portions 1b and 1f, plural bolt fitting holes 1c and 1e, and two openings 1d.

Each of the grilles 1a has an outer shape formed into a substantially circle shape and a mesh state with using a metal material. Each of the grilles 1a functions to make the acoustic wave, outputted from the diaphragm 17 being the component of the speaker unit 50, pass through to outside. One of the two grilles 1a is arranged at a position symmetrical to the other grille 1a with respect to a central axis L2 including a center of a longitudinal direction of the first cabinet 1.

Each of the hook portions 1b is formed into a recessed and hook shape. Each of the hook portions 1b is provided at a position with a constant space in the longitudinal direction (upper direction and lower direction) of the first cabinet 1 with respect to the central axis L3 on the front side of the first cabinet 1, respectively. In addition, each of the hook portions 1b is provided between the front side of the first cabinet 1 and the left side surface thereof and between the front side of the first cabinet 1 and the right side surface thereof, respectively. Each of the hook portions 1b is engaged with each of hook portions 3d or 4d provided on the logo-mark printed panel 3 and the metal attaching side panel 4, which will be described later.

Each of the hook portions 1f is formed into a recessed and hook shape. Each of the hook portions 1f is provided at each position of four corners on the rear side of the first cabinet 1, respectively. Each of the hook portions 1f is engaged with each of hook portions 3b or 4b provided on the logo-mark printed panel 3 and the metal attaching side panel 4, respectively.

Each of the bolt fitting holes 1c is provided at a position in the vicinity of each of the hook portions 1f on the rear side of the first cabinet 1, respectively. Each of the bolt fitting holes 1c is the bolt fitting hole engaged with the bolt, and each of them is used when the first cabinet 1 and the second cabinet 2 are engaged.

Each of the bolt fitting holes 1e is provided in the vicinity of an outer circumference of each of the grilles 1a on the rear side of the first cabinet 1 with an appropriate space, respectively. Each of the bolt fitting holes 1e is the bolt fitting hole engaged with the bolt, and each of them is used when the speaker unit 50 is mounted on the first cabinet 1.

Each of the openings 1d is provided on the central axis L3 on the rear side and the side surface side of the first cabinet 1, respectively. In addition, one of the two openings 1d is arranged at a position symmetrical to the other opening 1d with respect to a central axis L2 including the center of the lateral direction of the first cabinet 1. Each of the openings 1d is an opening into which the bolt is inserted, and each of them is used when the first cabinet 1 and the second cabinet 2 are engaged.

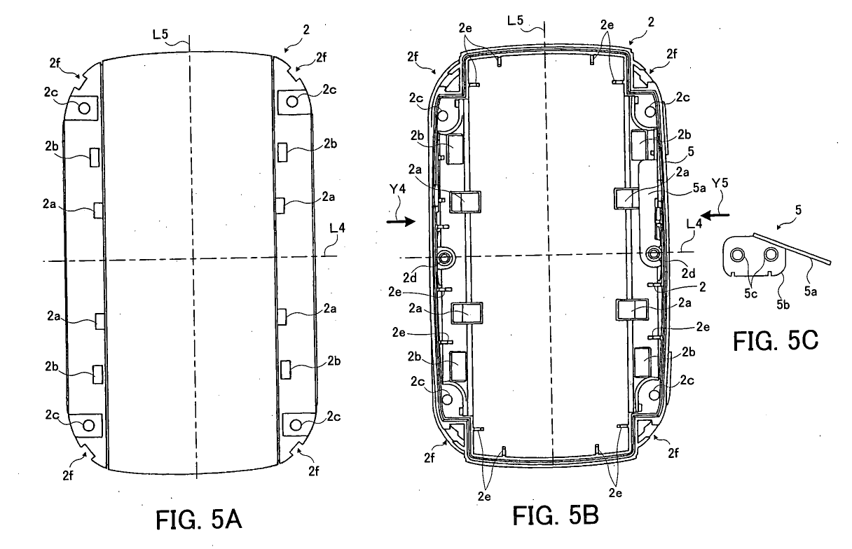

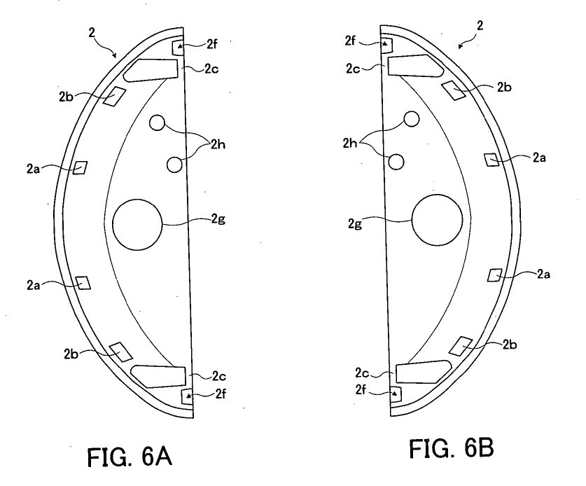

Next, a configuration of the second cabinet 2 will be explained with reference to FIGS. 5A to 5C and FIGS. 6A and 6B.

FIG. 5A shows a front view of the second cabinet 2, and FIG. 5B shows a rear view of the second cabinet 2. FIG. 5C is a side view of a metal fitting part 5 mounted on the inner side surface of the second cabinet 2 when observed from an arrow Y4 direction shown in FIG. 5B. FIG. 6A is a side view of the second cabinet 2 when observed from the arrow Y4 direction shown in FIG. 5B. Meanwhile, FIG. 6B is a side view of the second cabinet 2 when observed from an arrow Y5 direction opposite to the arrow Y4 direction shown in FIG. 5B.

The second cabinet 2 has a substantially rectangular plane shape and a substantially half-ellipse side shape. The second cabinet 2 includes two pairs of openings 2a, plural hook portions 2b and 2f, plural openings 2c, plural bolt fitting holes 2d, plural projections 2e, two openings 2g, and two pairs of openings 2h.

The two pairs of openings 2a are provided on the front side of the second cabinet 2 and at positions away from a central axis L4 including the center of the longitudinal direction of the second cabinet 2 by a constant distance in the longitudinal direction (upper side direction and lower side direction), respectively. As shown in FIGS. 5A to 5c, the two pairs of openings 2a are provided at the positions in the vicinity of the left and right side surfaces of the second cabinet 2. The one pair of openings 2a provided on the right side of the drawing are arranged at positions symmetrical to the other pair of openings 2a provided on the left side of the drawing with respect to a central axis L5 including the center of the lateral direction of the second cabinet 2. Into the two pairs of openings 2a, respective projections 3a provided on the logo-mark printed panel 3 and respective projections 4a provided on the metal attaching side panel 4, which will be described later, are inserted.

Each of the hook portions 2b is formed into a recessed and hook shape. Each of the hook portions 2b is provided on the front side of the second cabinet 2 and at a position away from the central axis L4 with a constant space in the longitudinal direction (upper direction and lower direction) of the second cabinet 2. As shown in FIGS. 5A to 5C, each of the hook portions 2b is provided at a position in the vicinity of the left and right surface sides of the second cabinet 2, and each of the hook portions 2b positioned on the right side of the drawing is arranged at a position symmetrical to each of the hook portions 2b positioned on the left side of the drawing with respect to the central axis L5 including the center of the lateral direction of the second cabinet 2. Further, a distance from the position of each of the hook portions 2b to the central axis L4 becomes larger than a distance from the position of each of the openings 2a to the central axis L4. Each of the hook portions 2b is engaged with each of the hook portions 3c provided on the logo-mark printed panel 3 and each of the hook portions 4c provided on the metal attaching side panel 4, which will be explained later.

Each of the hook portions 2f is formed into the same shape as that of each of the above-mentioned hook portions 1f. Each of the hook portions 2f is provided at each position at four corners on the rear side of the second cabinet 2. Each of the hook portions 2f is engaged with each of the hook portions 3b and 4b provided on the logo-mark printed panel 3 and the metal attaching side panel 4, respectively.

Each of the openings 2c is provided on the rear side of the second cabinet 2 and at a position in the vicinity of each of the hook portions 2f, respectively. In addition, each of the openings 2c is an opening into which the bolt is inserted, and each of them is used when the first cabinet 1 and the second cabinet 2 are engaged.

Each of the bolt fitting holes 2d is provided on the rear side of the second cabinet 2 and on the central axis L4. One of the two bolt fitting holes 2d is arranged at a position symmetrical to the other bolt fitting hole 2d with respect to the central axis L5 including the center of the lateral direction of the second cabinet 2. In addition, each of the bolt fitting holes 2d is provided at a position corresponding to each of the openings 1d provided on the first cabinet 1 when the first cabinet 1 and the second cabinet 2 are engaged. Each of the bolt fitting holes 2d is a bolt fitting hole to which the bolt is fit, and each of them is used when the first cabinet 1 and the second cabinet 2 are engaged.

Each of the projections 2e is a projecting portion formed on the inner side surface of the second cabinet 2 with an appropriate space. In FIG. 5B, each of the projections 2e is formed to project to the front side of the drawing. Each of the projections 2e contacts the inner side surface of the first cabinet 1 in such a state that the first cabinet 1 and the second cabinet 2 are engaged. Each of the projections 2e functions to regulate movement of the second cabinet 2 with respect to the first cabinet 1.

Each of the openings 2g is formed at a substantially middle portion on the left and right side surfaces with respect to the longitudinal direction of the second cabinet 2. One of the two openings 2g is formed at a position corresponding to the other opening 2g. Each of the openings 2g functions to draw the output wiring 25 of the amplifier, electrically connected to the voice coil 14 of the speaker unit 50 at the terminal portion, to outside, i.e., to the amplifier (see FIG. 1D).

The two pairs of openings 2h are formed at substantial middle positions on the left and right side surfaces with respect to the longitudinal direction of the second cabinet 2, respectively. One of the two pairs of openings 2h is formed at positions corresponding to the other pair of openings 2h. One of the two pairs of openings 2h are used when the metal fitting part 5 is mounted. The metal fitting part 5 is formed into a shape shown in FIGS. 5B and 5C, and it has a shape formed by combining a plane first part 5a and a plane second part 5b. On the second part 5b, a pair of bolt fitting holes 5c is formed. The metal fitting part 5 is mounted on the inner side surface of the second cabinet 2 so that the pair of bolt fitting holes 5c corresponds to one of the above-mentioned two pairs of openings 2h. The shape of the metal fitting part 5 mounted on the left inner side surface with respect to the longitudinal direction of the second cabinet 2 is different from the shape of the metal fitting part 5 (the metal fitting part 5 shown in FIG. 5B) mounted on the right inner side surface with respect to the longitudinal direction of the second cabinet 2, and both of them are symmetrical to each other.

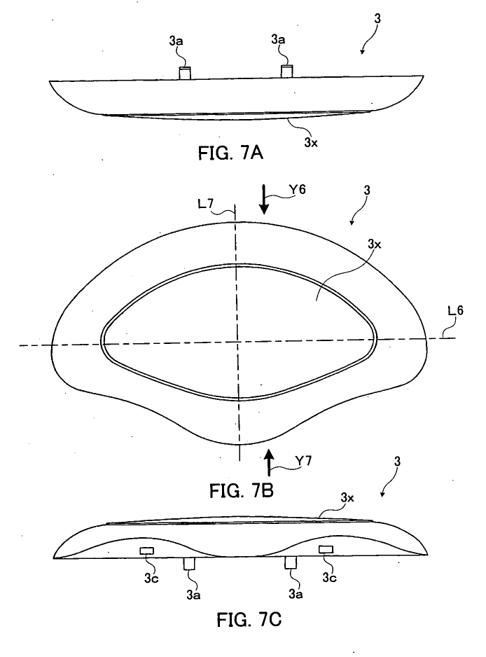

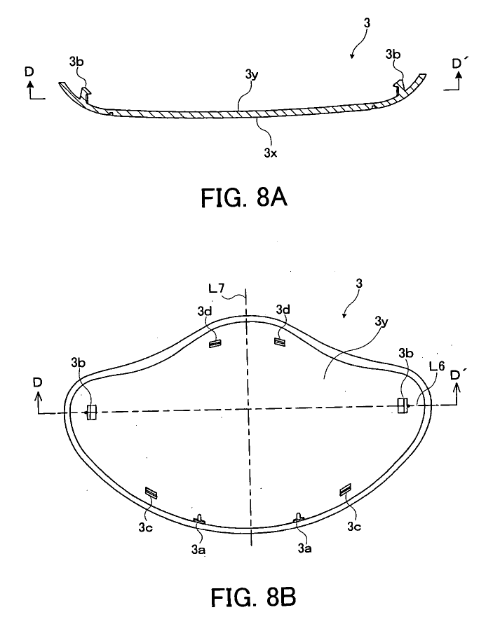

Next, a description will be given of a configuration of the logo-mark printed panel 3 with reference to FIGS. 7A to 7C and FIGS. 8A and 8B.

FIG. 7B shows a front view of the logo-mark printed panel 3. FIG. 7A shows a side view of the logo-mark printed panel 3 when observed from an arrow Y6 direction in FIG. 7B. Meanwhile,

FIG. 7C shows a side view of the logo-mark printed panel 3 when observed from an arrow Y7 direction opposite to the arrow Y6 direction shown in FIG. 7B. FIG. 8B shows a rear view the logo-mark printed panel 3. FIG. 8A shows a cross-sectional view along a cutting-line D-D′ shown in FIG. 8B.

The logo-mark printed panel 3 is formed into a substantial dish shape. Additionally, the logo-mark printed panel 3 has a shape formed by combining a substantial mountain-shaped plane shape and a substantially half-elliptic plane shape. Returning to FIGS. 1A to 1D, the logo-mark printed panel 3 is mounted on the side surface corresponding to the arrow Y1 direction of the cabinet 70 (i.e., on the left side surface with respect to the longitudinal direction of the cabinet 70 in FIG. 1C) or on the side surface corresponding to the side surface corresponding to the arrow Y2 direction (i.e., on the right side surface with respect to the longitudinal direction of the cabinet 70 in FIG. 1C), when the first cabinet 1 and the second cabinet 2 are engaged. Characters (not shown), such as a product name, a trademark and/or a business name, are printed on the side of a front surface 3x of the logo-mark printed panel 3 by serigraph. Plural projections 3a, a pair of hook portions 3b and plural hook portions 3c and 3d are formed on the side of a rear surface 3y of the logo-mark printed panel 3.

Each of the projections 3a is formed in the vicinity of a peripheral edge portion of the substantially half-elliptic plane shown in FIG. 8B and at a position away from a central axis L7 including the center of the longitudinal direction of the logo-mark printed panel 3 by a constant distance in the longitudinal direction (left side direction and right side direction). Each of the projections 3a is formed to project to the front side of the drawing in FIG. 8B. Each of the projections 3a is inserted into each of the openings 2a provided in the second cabinet 2, and it has a function of regulating movement of the logo-mark printed panel 3 with respect to the second cabinet 2.

The pair of hook portions 3b are formed into projecting and substantial “L” shape, respectively. They are formed on the long axis L6 of the logo-mark printed panel 3 and in the vicinity of the peripheral edge portion of the logo-mark printed panel 3, respectively. In addition, one of the pair of hook portions 3b is formed at a position symmetrical to the other hook portion 3b with respect to the central axis L7. Each of the hook portions 3b is engaged with the hook portion 1f of the first cabinet 1 or the hook portion 2f of the second cabinet 2 when the first cabinet 1 and the second cabinet 2 are engaged.

Each of the hook portions 3c is formed into a projecting and substantial “L” shape, and it is formed in the vicinity of a peripheral edge portion of the part formed into a substantially half-elliptic shape in FIG. 8B and at a position in the longitudinal direction (left side direction and right side direction) of the logo-mark printed panel 3 with respect to the central axis L7 with a constant space. In addition, one of the two hook portions 3c is formed at a position symmetrical to the other hook portion 3c with respect to the central axis L7. Further, a distance from each of the hook portions 3c to the central axis L7 becomes larger than a distance from the position of each of the projections 3a to the central axis L7. Each of the hook portions 3c is engaged with each of the hook portions 2b provided on the second cabinet 2 when the first cabinet 1 and the second cabinet 2 are engaged.

Each of the hook portions 3d is formed in the vicinity of the peripheral edge portion of the part formed into the substantial mountain shape in FIG. 8B and at a position in the longitudinal direction (left side direction and right side direction) of the logo-mark printed panel 3 with respect to the central axis L7 with a constant space. In addition, each of the hook portions 3d is formed at a position substantially symmetrical to each of the projections 3a with respect to the long axis L6. Each of the hook portions 3d is formed to project to the front side of the drawing in FIG. 8B. Each of the hook portions 3d is engaged with each of the hook portions 1b provided on the first cabinet 1 when the first cabinet 1 and the second cabinet 2 are engaged.

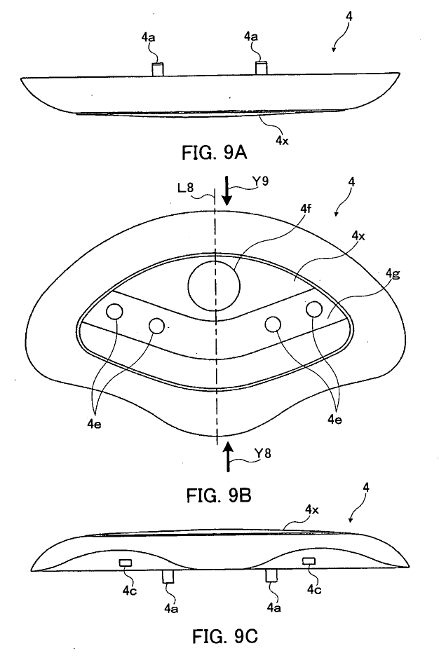

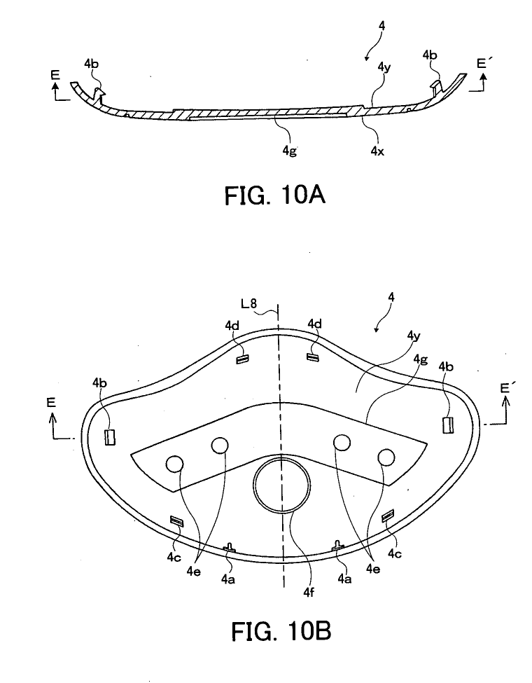

Next, a description will be given of a configuration of the metal attaching side panel 4 with reference to FIGS. 9A to 9C and FIGS. 10A and 10B.

FIG. 9B shows a front view of the metal attaching side panel 4. FIG. 9A shows a side view of the metal attaching side panel 4 when observed from an arrow Y9 direction shown in FIG. 9B. Meanwhile, FIG. 9C shows a side view of the metal attaching side panel 4 when observed from an arrow Y8 direction opposite to the arrow Y9 direction shown in FIG. 9B. FIG. 10B shows a rear view of the metal attaching side panel 4. FIG. 10A shows a cross-sectional view along a cutting-line E-E′ shown in FIG. 10B.

The metal attaching side panel 4 has the substantially same shape as the shape of the logo-mark printed panel 3. Similarly to the logo-mark printed panel 3, the metal attaching side panel 4 is mounted on the left side surface or the right side surface with respect to the longitudinal direction of the cabinet 70 shown in FIG. 1C, when the first cabinet 1 and the second cabinet 2 are engaged. Concretely, when the logo-mark printed panel 3 is mounted on the left side surface with respect to the longitudinal direction of the cabinet 70, the metal attaching side panel 4 is mounted on the right side surface with respect to the longitudinal direction of the cabinet 70. Meanwhile, when the metal attaching side panel 4 is mounted on the left side surface with respect to the longitudinal direction of the cabinet 70, the logo-mark printed panel 3 is mounted on the right side surface with respect to the longitudinal direction of the cabinet 70.

Components, such as the plural projections 4a, the pair of hook portions 4b, the plural hook portions 4c and 4d, are formed on the rear surface 4y of the metal attaching side panel 4. The components are formed on the rear surface 4y of the metal attaching side panel 4 at the positions corresponding to the positions of the components (i.e., the plural projections 3a, the pair of hook portions 3b, the plural hook portions 3c and 3d) provided on the rear surface 3y of the logo-mark printed panel 3. Thus, the respective components of the metal attaching side panel 4 have the same functions as those of the respective components of the logo-mark printed panel 3.

However, when the metal attaching side panel 4 and the logo-mark printed panel 3 are compared, the metal attaching side panel 4 is different from the logo-mark printed panel 3 in that the metal attaching side panel 4 has a groove 4g formed into a “<” shape, two pairs of openings 4e and an opening 4f. The groove 4g is formed on the front surface 4x of the metal attaching side panel 4, and a metal part 6a of the flexible arm 6 is fixed into the groove 4g, as shown in FIG. 1D.

The flexible arm 6 is a known member, and it serves as the metal fitting part by which the speaker device 100 of the present invention is mounted on the mounting base. In addition, the flexible arm 6 functions to freely adjust a mounting angle of the speaker device 100 with respect to the mounting base. A pair of openings 6b is formed on the metal part 6a. In FIG. 9B and FIG. 10B, one of the two pairs of openings 4e formed in the groove 4g are formed at positions symmetrical to the other pair of openings 4e with respect to a central axis L8 including the center of the longitudinal direction of the metal attaching side panel 4. One of the two pairs of openings 4e is used when the metal part 6a of the flexible arm 6 is fixed by using the bolt, as shown in FIG. 1D.

The opening 4f is formed at a position in the vicinity of the substantially middle of the groove 4g. In addition, the opening 4f is formed at a position corresponding to the opening 2g provided on the second cabinet 2 when the metal attaching side panel 4 is mounted on the side surface of the cabinet 70. The opening 4f functions to draw the output wiring 25 of the amplifier electrically connected to the voice coil 14 being the component of the speaker unit 50 to the amplifier.

The first cabinet 1, the second cabinet 2, the logo-mark printed panel 3 and the metal attaching side panel 4, having the above-mentioned configurations, are combined, and the housing which houses the speaker unit 50 is manufactured. Additionally, the speaker unit 50 is housed into the housing, and the speaker device 100 shown in FIGS. 1A to 1D and FIGS. 2A and 2B is formed.

(Manufacturing Method of Speaker Device)

Next, a description will be given of a manufacturing method of the speaker device 100 with reference to the above-mentioned appropriate drawings. A manufacturing order which will be described below is only an example, and the order is suitably changeable.

First, the metal fitting part 5 is mounted on the inner surface side of the second cabinet 2. Specifically, the metal fitting part 5 is mounted on the inner side surface of the second cabinet 2 in such a state that the position of an optional one of the two pairs of openings 2h provided on the second cabinet 2 coincides with the position of the pair of bolt fitting hole 5c of the metal fitting part 5. FIG. 2B and FIG. 5B show such a state that the metal fitting part 5 is mounted on the inner side surface of the second cabinet 2 in this manner, respectively.

Next, the speaker unit 50 is mounted on the rear surface side of the first cabinet 1. Specifically, first, each opening (not shown) provided at an appropriate position of the frame 15 being the component of the speaker unit 50 is positioned to coincide with a position of each correspondent bolt fitting hole 1e provided on the first cabinet 1, and the speaker unit 50 is arranged at a position corresponding to the grille 1a on the rear surface side of the first cabinet 1. Subsequently, each of the bolts is inserted into each of the openings of the speaker unit 50 from the rear surface side of the first cabinet 1, and each of them is fit to each of the bolt fitting holes 1e. FIGS. 2A and 2B show such a state that the speaker unit 50 is mounted on the rear surface side of the first cabinet 1 in this manner.

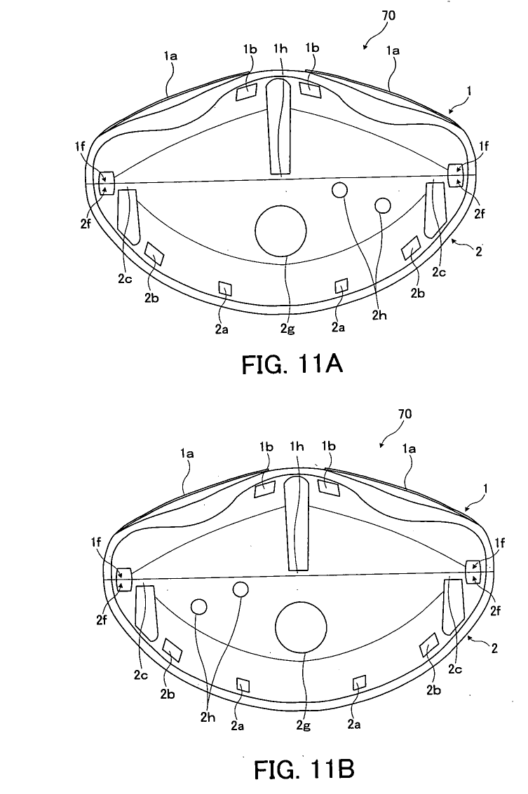

Next, the first cabinet 1 and the second cabinet 2 are engaged, and the cabinet 70 is manufactured. Specifically, the rear side of the first cabinet 1 is placed opposite to the rear side of the second cabinet 2, and they are engaged. Thereby, the cabinet 70 is manufactured. FIGS. 11A and 11B show such a state that the first cabinet 1 and the second cabinet 2 are engaged, respectively. FIG. 11A shows a right-side view of the cabinet 70 when observed from the arrow Y2 direction shown in FIG. 1C. Meanwhile, FIG. 11b shows a left-side view of the cabinet 70 when observed from the arrow Y1 direction opposite to the arrow Y2 direction shown in FIG. 1C. At this time, the output wiring 25 of the amplifier electrically connected to the voice coil 14 being the component of the speaker unit 50, is drawn outside of the cabinet 70 through the opening 2g provided on the second cabinet 2.

When the cabinet 70 thus manufactured is observed, the left side surface of the cabinet 70 and the right side surface thereof are formed into the same shape, as shown in FIGS. 11A and 11B, and the side surfaces thereof have the shapes to be engaged with the rear sides of the logo-mark printed panel 3 and the metal attaching side panel 4. Further, the respective components such as the hook portions and the openings provided on the left side surface of the cabinet 70 are arranged at the positions corresponding to the respective components such as the hook portions and the openings provided on the right side surface of the cabinet 70.

Next, as an example, the metal attaching side panel 4 is mounted on the right side surface with respect to the longitudinal direction of the cabinet 70. Of course, in the present invention, the metal attaching side panel 4 can be mounted on the left side surface with respect to the longitudinal direction of the cabinet 70. Specifically, the rear surface of the metal attaching side panel 4 is placed opposite to the right side surface of the cabinet 70, and each of the projections 4a provided on the rear surface of the metal attaching side panel 4 is inserted into each of the correspondent openings 2a provided on the second cabinet 2. Then, the metal attaching side panel 4 is pressed on the side of the cabinet 70 with constant external force. Thereby, each of the hook portions 4d is engaged with each of the correspondent hook portions 1b. In addition, one of the pair of hook portions 4b is engaged with the hook portions 1f and 2f, and the other of the pair of hook portions 4b is also engaged with the other hook portions 1f and 2f. Additionally, each of the hook portions 4c is engaged with each of the correspondent hook portions 2b. The opening 4f is arranged at the position corresponding to the opening 2g. At this time, the output wiring 25 of the amplifier, drawn to the outer side through the opening 2g of the cabinet 70, is drawn to the outer side of the metal attaching side panel 4 through the opening 4f provided on the metal attaching side panel 4. FIG. 1D shows such a state that the metal attaching side panel 4 is mounted on the right side surface of the cabinet 70 in this manner.

Next, as shown in FIG. 1D, the flexible arm 6 is mounted on the front surface 4x of the metal attaching side panel 4. Of course, in the present invention, before the metal attaching side panel 4 is mounted on the right side surface of the cabinet 70, the flexible arm 6 may be mounted on the metal attaching side panel 4 in advance. Specifically, the metal part 6a is arranged into the groove 4g provided on the front surface 4x of the metal attaching side panel 4 in such a state that the positions of the pair of openings 6b provided at the metal part 6a of the flexible arm 6 coincide with the positions of the correspondent pair of openings 4e in the two pairs of openings provided on the metal attaching side panel 4. Afterward, each of the bolts is inserted into the pair of openings 6b provided at the metal part 6a and the pair of opening 4e from the side of the front surface 4x of the metal attaching side panel 4 in this order, and each of them is fit to the above-mentioned pair of bolt fitting holes 5c of the metal fitting part 5. FIG. 1D shows such a state that the flexible arm 6 is mounted on the metal attaching side panel 4 in this manner.

Next, the logo-mark printed panel 3 is mounted on the left side surface with respect to the longitudinal direction of the cabinet 70. A method thereof is the same as the above-mentioned method of mounting the metal attaching side panel 4 on the right side surface of the cabinet 70. Thereby, each of the hook portions 3d is engaged with each of the correspondent hook portions 1b. In addition, one of the pair of hook portions 3b is engaged with the hook portions 1f and 2f, and the other of the pair of hook portions 3b is engaged with the other hook portions 1f and 2f.

FIG. 1B shows such a state that the logo-mark printed panel 3 is mounted on the left side surface of the cabinet 70 in this manner. By the above-mentioned method, the speaker device 100 shown in FIGS. 1A to 1D is manufactured.

(Mounting Example to Vehicle Interior)

The speaker device 100 according to the first embodiment of the present invention is the satellite-type speaker device, as described above. Therefore, as a general usage method, at least the pair of speaker devices 100 for left and right channels are used in such a state that they are hanged from left and right rear trims provided behind the backseat in the vehicle interior or the assist grip.

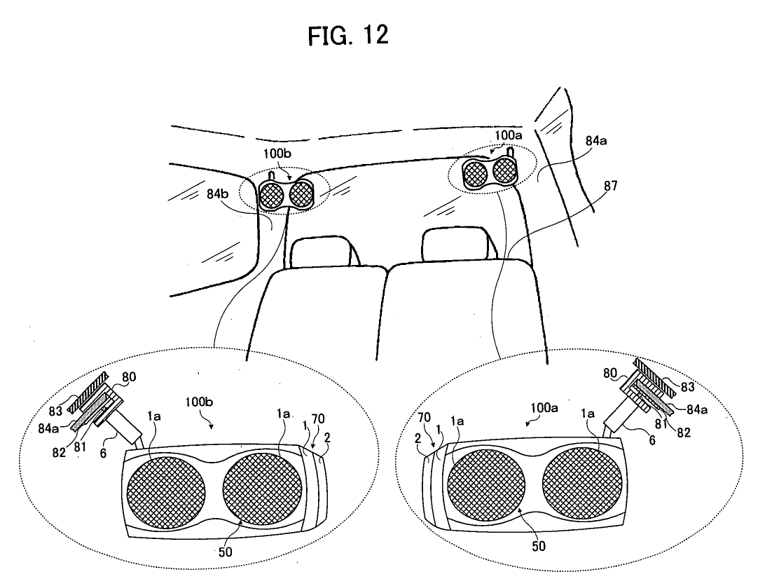

Now, a description will be given of an example of a mounting method onto a vehicle interior with reference to FIG. 12. FIG. 12 shows such a state that the pair of speaker devices 100 for the left and right channels is mounted on the left and right rear trims provided behind a backseat 87 in the vehicle interior, respectively. In FIG. 12, a reference numeral 83 indicates a body of the vehicle.

First, as shown in enlarged areas surrounded by broken-lines, the pair of speaker devices 100 for the left and right channels, metal fitting parts 80 having a cross-sectional shape formed into a “Π” shape, bolts 81 and trim holding metal parts 82 having a plane shape are prepared.

Of course, the speaker device 100 according to the first embodiment of the present invention is used as a speaker device 100a for a left channel and a speaker device 100b for a right channel. The metal fitting part 5 (hereinafter, also referred to as “left metal fitting part”) is mounted on the right inner side surface (at the same position as the metal fitting part 5 shown in FIG. 5B) of the second cabinet 2 in the speaker device 100a for the left channel in advance. Inversely, the metal fitting part 5 (hereinafter, also referred to as “right metal fitting part”) is mounted on the left inner side surface (at a position opposite to the metal fitting part 5 shown in FIG. 5B) of the second cabinet 2 in the speaker device 100b for the right channel in advance. In addition, the speaker device 100a for the left channel functions to output the acoustic wave into the right space of the vehicle interior when observed on the drawing, i.e., into the left space in the vehicle interior with respect to a traveling direction of the vehicle. Meanwhile, the speaker device 100b for the right channel functions to output the acoustic wave into the right space in the vehicle interior with respect to the traveling direction of the vehicle.

Next, the flexible arm 6 is mounted on the speaker devices 100 for the left and right channels, respectively. Specifically, first, in the case of the speaker device 100a for the left channel, the metal part 6a of the flexible arm 6 is arranged in the groove 4g of the metal attaching side panel 4, corresponding to the position of the incorporated left metal fitting part. Then, each of the bolts is inserted into the pair of openings 6b and the pair of openings 4e from the side of the front surface 4x of the metal attaching side panel 4 in this order, and each of them is fit to the pair of bolt fitting holes 5c provided on the left metal fitting part. Thereby, the flexible arm 6 is mounted on the speaker device 100a for the left channel. In such a state, a positional relation between the speaker unit 50 and the flexible arm 6 is as follows. Namely, in the speaker device 100a for the left channel, the flexible arm 6 is mounted on the grille 1a on which no speaker unit 50 is arranged. In addition, by the similar method, in the case of the speaker device 100b for the right channel, the metal part 6a of the flexible arm 6 is arranged in the groove 4g of the metal attaching side panel 4, corresponding to the position of the right metal fitting part mounted on the inner portion. Then, each of the bolts is inserted into the pair of openings 6b and the pair of openings 4e from the side of the front surface 4x of the metal attaching side panel 4 in this order, and each of them is fit to the pair of bolt fitting holes 5c provided on the right metal fitting part. Thereby, the flexible arm 6 is mounted on the speaker device 100b for the right channel. In such a state, the positional relation between the speaker unit 50 and the flexible arm 6 is as follows. Namely, in the speaker device 100b for the right channel, the flexible arm 6 is mounted on the grille 1a on which no speaker unit 50 is arranged.

Next, the speaker devices 100 for the left and right channels are mounted on left and right rear trims 84a and 84b provided behind the backseat 87 in the vehicle interior, respectively. A method thereof will be explained with the speaker device 100a for the left channel as an example. First, the metal fitting part 80 is mounted on one end side of the flexible arm 6 mounted on the speaker device 100a for the left channel by using the bolt. Next, as shown in FIG. 12, the angle of the flexible arm 6 is adjusted so that the grille 1a of the speaker device 100a for the left channel faces to the side of the seat. Subsequently, the metal fitting part 80 is inserted between the left rear trim 84a and the vehicle body 83, and the bolt 81 is screwed to the side of the left rear trim 84a from the side of the flexible arm 6. Thereby, the left rear trim 84a is sandwiched by the metal fitting part 80 and the trim holding metal part 82. In this manner, as shown in FIG. 12, the speaker device 100a for the left channel is mounted on the left rear trim 84a in the vehicle interior. In addition, by the similar method, as shown in FIG. 12, the speaker device 100b for the right channel is mounted on the right rear trim 84b in the vehicle interior.

In such a state, the relative arrangement relation between the speaker device 100a for the left channel and the speaker device 100b for the right channel is as follows. In FIG. 12, the speaker unit 50 housed into the speaker device 100a for the left channel is positioned at the position corresponding to the grille 1a positioned on the left side of the illustration of the two grilles 1a. Meanwhile, the speaker unit 50 housed into the speaker device 100b for the right channel is positioned at the position corresponding to the grille 1a positioned on the right side of the illustration of the two grilles 1a. By the above-mentioned method, the pair of speaker devices 100 for the left and right channels is mounted on the left and right rear trims 84 provided behind the backseat 87 in the vehicle interior, respectively.

Next, a description will be given of characteristic operation and effect of the speaker device 100 according to the first embodiment of the present invention.

In the speaker device 100 according to the first embodiment of the present invention, as for the cabinet 70 manufactured when the first cabinet 1 housing the speaker unit 50 serving as the generation source of the sound and the second cabinet 2 are engaged, its one side surface (left side surface) with respect to the longitudinal direction is formed into the same shape as other side surface (right side surface) opposite to the one side surface. In addition, the rear surface 3y of the logo-mark printed panel 3 is formed into the substantially same shape as the rear surface 4y of the metal attaching side panel 4. The rear surface 3y of the logo-mark printed panel 3 and the rear surface 4y of the metal attaching side panel 4 are formed into shapes to be engaged with both of the one side surface (left side surface) and the other side surface (right side surface) with respect to the longitudinal direction of the cabinet 70.

Therefore, when the pair of speaker devices for the left and right channels such as a speaker device for a vehicle has to be mounted on the vehicle interior, there is an advantage which will be described below.

Namely, if the logo-mark printed panel 3 or the metal attaching side panel 4 is mounted on the left side surface with respect to the longitudinal direction of the cabinet 70, and if the metal attaching side panel 4 or the logo-mark printed panel 3 is accordingly mounted on the right side surface with respect to the longitudinal direction of the cabinet 70, the pair of speaker devices for the left and right channels can be easily formed. That is, each component, i.e., the first cabinet 1, the second cabinet 2, the logo-mark printed panel 3 and the metal fitting part side panel 4, can be shared for the speaker devices for the left and right channels. Therefore, according to the present invention, the number of metal mold parts for manufacturing the above-mentioned respective components can be reduced as compared with a speaker device in such a type that the above-mentioned correspondent components cannot be shared. Additionally, since the number of component parts can be reduced, the management of each component part becomes easier.

The two openings 2g through which the output wiring 25 of the amplifier electrically connected to the voice coil 14 of the speaker unit 50 is drawn to outside are formed on the one side surface of the second cabinet 2 and the other side surface opposite to the one side surface. Thereby, the output wiring 25 of the amplifier electrically connected to the voice coil 14 of the speaker unit 50 can be drawn to outside through each of the openings 2g. Therefore, it becomes possible to connect the output wiring 25 and the output terminal of the amplifier. In addition, the opening 2g formed on the one side surface of the second cabinet 2 is formed at the position corresponding to the opening 2g formed on the other side surface of the second cabinet 2. Therefore, the output wiring 25 can be drawn to outside through the opening 2g formed on the one side surface. Inversely, the output wiring 25 can be drawn to outside through the opening 2g formed on the above-mentioned other side surface. Thus, when the direction of drawing of the output wiring 25 of the speaker device 100a for the left channel to outside has to be different from the direction of drawing of the speaker device 100b for the right channel to outside, this can be realized. Namely, when the output wirings 25 are drawn to outside in the speaker device 100a for the left channel and the speaker device 100b for the right channel, each of the openings 2g can be shared.

When the metal attaching side panel 4 is mounted on the one side surface or the other side surface of the cabinet 70, the metal attaching side panel 4 has the opening 4f at a position corresponding to each of the openings 2g of the second cabinet 2. Thereby, the output wiring 25 of the amplifier electrically connected to the voice coil 14 of the speaker unit 50 can be drawn to outside through the opening 2g of the second cabinet 2 and the opening 4f of the metal attaching side panel 4.

### Second Embodiment

Next, a description will be given of a configuration of the speaker device according to a second embodiment of the present invention.

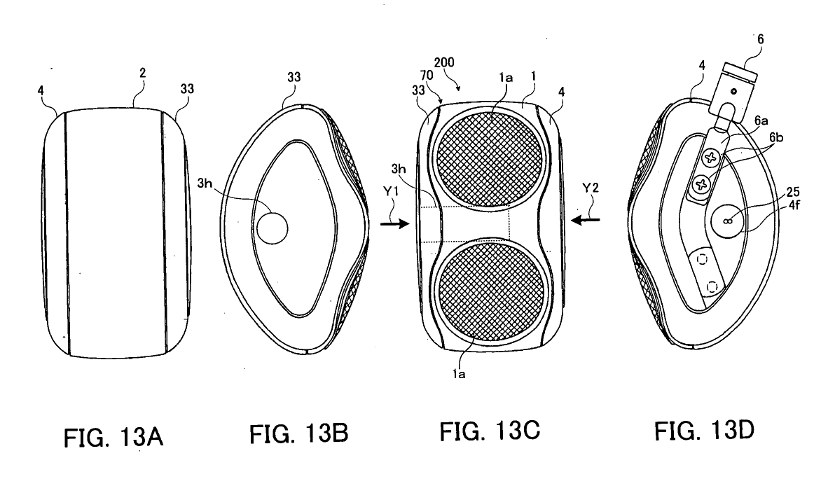

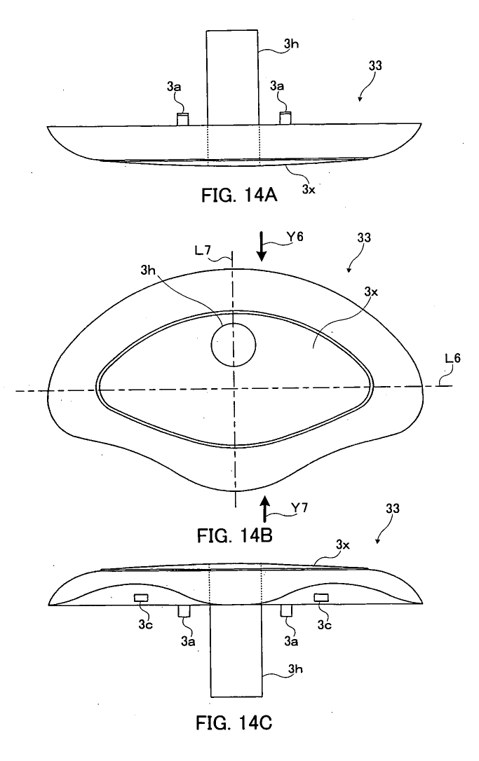

The speaker device according to the second embodiment of the present invention has the configuration substantially similar to that of the above-mentioned first embodiment. However, in the second embodiment, a bass reflex duct is provided in the speaker device 100 according to the first embodiment, and the speaker device of the bass reflex type is formed. In this point, the second embodiment is different from the above-mentioned first embodiment. Hence, the different point will be explained below, with reference to FIGS. 13A to 13D and FIGS. 14A to 14C. In FIGS. 13A to 13D and FIGS. 14A to 14C, the same reference numerals are given to the same components as those of the first embodiment, and explanations thereof will be omitted.

FIGS. 13A to 13D show diaphragms of the speaker device according to the second embodiment of the present invention when observed from the front direction, the rear direction, the direction of the left side surface and the direction of the right side surface, respectively. In FIGS. 13A to 13D, the configurations of the respective components other than a logo-mark printed panel 33, i.e., the configurations of the first cabinet 1, the second cabinet 2 and the metal attaching side panel 4, are similar to the components shown in FIGS. 1A to 1D. FIG. 13C shows a front view of a speaker device 200, and FIG. 13A shows a rear view of the speaker device 200. FIG. 13B shows a left side view of the speaker device 200 shown in FIG. 13A when observed from the arrow Y1 direction, and FIG. 13D shows a right side view of the speaker device 200 shown in FIG. 13A when observed from the arrow Y2 direction opposite to the arrow Y1 direction.

FIG. 14B shows a front view of the logo-mark printed panel 33 according to the second embodiment. FIG. 14A shows a side view of the logo-mark printed panel 33 when observed from the arrow Y6 direction in FIG. 14B. Meanwhile, FIG. 14C shows a side view of the logo-mark printed panel 33 when observed from the arrow Y7 direction opposite to the arrow Y6 direction in FIG. 14B.

The second embodiment is different from the first embodiment in only the configuration of the logo-mark printed panel 33. Namely, the logo-mark printed panel 33 according to the second embodiment has a bass reflex duct 3h formed into a cylindrical shape, as shown in FIGS. 14A to 14C. The bass reflex duct 3h is formed to project to the rear side of the logo-mark printed panel 33. In addition, as understood by comparing the logo-mark printed panel 33 and the metal attaching side panel 4, the bass reflex duct 3h is formed at a position corresponding to the opening 4f provided on the metal attaching side panel 4. The bass reflex duct 3h is formed at a position corresponding to the opening 2g provided on the left side surface or the right side surface of the second cabinet 2, when the logo-mark printed panel 33 is mounted on the left side surface or the right side surface with respect to the longitudinal direction of the cabinet 70 manufactured by engaging the first cabinet 1 and the second cabinet 2. The bass reflex duct 3h is used in a state that it is inserted into one of the two openings 2g provided on the second cabinet 2. At this time, the other opening 2g is used as an opening through which the output wiring 25 of the amplifier electrically connected to the voice coil 14 being the component of the speaker unit 50 is drawn to outside. FIG. 13C shows such a state that the logo-mark printed panel 33 having such a configuration is mounted on the left side surface with respect to the longitudinal direction of the cabinet 70.

In the speaker device 200 according to the second embodiment, at the time of the driving thereof, the acoustic wave outputted from the front surface side of the diaphragm 17 being the component of the speaker unit 50 is outputted to outside via the one of the grilles 1a. Meanwhile, the acoustic wave outputted from the rear surface side of the diaphragm 17 is outputted to outside via the bass reflex duct 3h. Namely, the speaker device 200 according to the second embodiment forms the speaker device of the bass reflex type.

The second embodiment having the above-mentioned configuration includes operation and effect which will be explained below.

Namely, in the speaker device 200 according to the second embodiment, the logo-mark printed panel 33 has the bass reflex duct 3h at the position corresponding to each of the openings 2g of the second cabinet 2 formed on the one side surface (left side surface) and the other side surface (right side surface) opposite to the one side surface with respect to the longitudinal direction of the cabinet 70. Therefore, when the logo-mark printed panel 33 is mounted on the one side surface (left side surface) of the cabinet 70, the bass reflex duct 3h can be provided on the one side surface. Inversely, when the logo-mark printed panel 33 is mounted on the other side surface (right side surface) of the cabinet 70, the bass reflex duct 3h can be provided on the other side surface. Thus, the bass reflex duct 3h can be shared by the speaker device 100a for the left channel and the speaker device 100b for the right channel. Thereby, if the logo-mark printed panel 33 or the metal attaching side panel 4 is mounted on the one side surface (left side surface) of the cabinet 70, or if the metal attaching side panel 4 or the logo-mark printed panel 33 is accordingly mounted on the other side surface (right side surface) with respect to the longitudinal direction of the cabinet 70, the pair of speaker devices for the left and right channels of the bass reflex type can be easily formed. The other operation and effect in the second embodiment are similar to those of the above-mentioned first embodiment.

[Modification]

In the above-mentioned first and second embodiments, the speaker unit 50 is provided at the position corresponding to the grille 1a. However, this invention is not limited to this. Namely, in this invention, the speaker units 50 may be provided at the positions corresponding to the two grilles 1a, respectively.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2005-128110 filed on Apr. 26, 2005 including the specification, claims, drawings and summary is incorporated herein by reference in its entirety.

What is claimed is:

1. A speaker device comprising:
a first cabinet on which a speaker unit is mounted;
a second cabinet which is engaged with the first cabinet;
a first side panel which is mounted on one side surface of the first cabinet and the second cabinet when the first cabinet and the second cabinet are engaged; and
a second side panel which is mounted on other side surface, opposite to the one side surface, of the first cabinet and the second cabinet when the first cabinet and the second cabinet are engaged,
wherein the one side surface and the other side surface are formed into a same shape, and each of the first side panel and the second side panel is formed into a shape to be engaged with the one side surface and the other side surface.

2. The speaker device according to claim 1, wherein an opening through which a wiring electrically connected to a voice coil of the speaker unit is drawn to outside is formed on the one side surface and the other side surface of the second cabinet, and the opening formed on the one side surface is formed at a position corresponding to the opening formed on the other side surface.

3. The speaker device according to claim 2, wherein the second side panel has an opening at a position corresponding to the opening when the second side panel is mounted on the one side surface or the other side surface.

4. The speaker device according to claim 1, wherein the second cabinet has a mounting portion on which a metal fitting part for mounting on a mounting base is mounted.

5. The speaker device according to claim 1, wherein a shape of the first side panel mounted on the one side surface or the other side surface is substantially same as a shape of the second side panel mounted on the one side surface or the other side surface.

6. The speaker device according to claim 1, wherein the first side panel has a bass reflex duct at a position corresponding to the opening formed on the one side surface and the other side surface.
